(19) United States
(12) Patent Application Publication
(10) Pub. No.: US 2006/0195689 A1
(43) Pub. Date: Aug. 31, 2006

(54) Authenticated and confidential communication between software components executing in un-trusted environments

(76) Inventors: Carsten Blecken, Mountain View, CA (US); David Znidarsic, Palo Alto, CA (US); Shailesh Agarwal, San Jose, CA (US); Rajen Bose, Santa Clara, CA (US)

Correspondence Address: WAGNER, MURABITO & HAO, LLP, TWO NORTH MARKET STREET, THIRD FLOOR, SAN JOSE, CA, 95113, US

(21) Appl. No.: 11/069,736

(22) Filed: Feb. 28, 2005

(51) Int. Cl. H04N 7/16; H04L 9/00; H04L 9/32; G06F 17/30; G06F 7/04; G06K 9/00; H03M 1/68; H04K 1/00

(52) U.S. Cl. 713/156; 713/175; 726/26

(57) ABSTRACT

A method and system for implementing secure communication in an un-trusted execution environment. The method includes transmitting respective first and second certificates between a first component and a second component, wherein the first certificate and the second certificate are respectively hidden within software code comprising the first component and the second component. A secure communication channel is then generated between the first component and the second component by the second component using a first public key of the first certificate and the first component using a second public key of the second certificate. The identity of the first component is verified by the second component checking the first certificate with respect to a certificate authority. The identity of the second component is verified by the first component checking the second certificate with respect to the certificate authority. Upon successful verification of the first certificate and the second certificate, a data exchange is implemented via the secure communication channel.

### FIELD OF THE INVENTION

The present invention is generally related to computer executed software. More particularly, the present invention is directed towards software component execution security.

### BACKGROUND OF THE INVENTION

The unauthorized distribution and/or use of software based products (e.g., software piracy, etc.) is becoming an increasingly serious problem for the computer software industry. Unauthorized distribution/use generally refers to the illegal copying, distribution, or use of software products, applications, services, and the like. According to software and computer industry associations (e.g., Business Software Alliance, etc.) a significant percentage (e.g., 30-36%) of all software in current use is unauthorized, unlicensed, or otherwise stolen, thereby causing significant lost revenue for publishers, which in turn results in higher prices for the users.

Unauthorized distribution/use problems apply to many different types of commercial software. Such software includes full-function commercial software obtained through pre-installation or professional installation, “shrink-wrapped” software, and the like. Such software can also include time-limited or function-restricted versions of commercial software. The unauthorized distribution/use problems include, for example, the borrowing and installing of a copy of a software application from a colleague, client over-use problems where more copies of the software are installed than licensed for, unauthorized copies of software distributed on refurbished or new computers, and overt counterfeiting problems where copyrighted programs are duplicated and sold.

A number of prior art solutions have been developed to reduce the problems presented by the unauthorized distribution/use of software products. The majority of these prior art solutions involve either physically securing the execution environment of the software, or using various encryption and encoding schemes to check for proper authorized use. Physically securing the computing environment generally requires strict control of access to the computer equipment. For example, workstations on a secure network can be physically located behind a strictly controlled doorway of a closed room. Such physical control, if applied rigorously enough, can be effective in preventing most distribution/use problems. However, for a typical commercial software product publisher, requiring such physical control in customer computer environments is not practical.

Consequently, most prior art software product protection schemes use some form of encryption and/or encoding to deter unauthorized distribution/use. A typical prior art scheme would use some version of SSL (Secure Sockets Layer), or Transport Level Security (e.g., TLS, detailed in IETF RFC 2246), to implement authentication of client components, server components, or both, as well as encryption during a communication session between components. Another prior art example are solutions such as Kerberos and SESAME, which will establish a secure and authenticated communication link with the help of a mutually trusted third party. However, this requires the third party to be available in the runtime environment continuously and the third party has to execute in a trusted environment. Furthermore, the configuration for such a system is considerable. These are the main reasons why solutions involving just the two communication parties are much more widespread.

Typically, the prior art establishment of authenticated and confidential communication between software components requires that at least one of the execution environments is trusted. An environment is trusted when the communication can only be conducted by the user of the software component via authorized means. However, if two software components are trying to communicate where one or more software components are running in an execution environment which can be easily compromised, for example in a semi-public or not easily securable computing environment, security of the communication can be easily compromised. The compromised communication, for example, could render other software protection mechanisms ineffective (e.g., cracked product activation keys, etc.).

The use of standard PKI (Public Key Infrastructure) technology to ensure authenticated communication is not sufficiently suited for these types of cases, since it requires an initial configuration of the software components. If the configuration is performed by an unauthorized party, or by an authorized party with malicious intent (e.g., hacker etc.), the content of the communication can be tampered with.

Even in those cases where additional prior art schemes for restricting physical access to computing equipment and restricting network access (e.g., by using strong and often changed passwords) are employed, this restricted physical and network access might be available to a party with malicious intent, thus defeating any security measures ensured by proper configuration. All of these measures are in many cases burdensome to the user of the software component and quite resource intensive.

The other aspect is the high administrative overhead of the configuration of secure connections. In most cases involving SSL, certificates need to be created, signed, deployed and updated. If this is not done correctly (e.g., due to human error) the security of the connection might be compromised. What is required is a solution that efficiently facilitates authenticated and confidential communication between software components.

### BACKGROUND OF THE INVENTION

Thus, given the need for authenticated and confidential communication between software components, a solution that provides software components having preinstalled, pre-configured, embedded secure communication functionality would provide a number of advantages in comparison to the prior art. Such a solution would place the burden of implementing a robust and secure communication infrastructure on the author/designer of the software component, as opposed to the user of the software component.

In one embodiment, the present invention is implemented as a computer implemented method for providing secure communication between software components executing in an un-trusted execution environment. The secure communication is implemented between a first software component and a second software component. The method includes transmitting a first certificate to the second component and transmitting a second certificate to the first component (e.g., a certificate exchange). The first certificate and the second certificate can be respectively hidden within software code comprising the first component and the second component. Similarly, respective first and second private keys can be hidden within the software code embodying the first component and the second component. Both of the certificates have to be signed by a mutually trusted certificate authority.

A secure communication channel is then generated between the first component and the second component by the second component using the first certificate (e.g., a first public key) and the first component using the second certificate (e.g., a second public key). The identity of the first component is then verified by the second component checking that the first certificate was signed by a trusted certificate authority As used herein, “identity” is the information provided by a party (e.g., the component builder) about itself before the certificate signing request is issued. The identity information resides inside the certificate together with the private key. The identity of the second component is verified by the first component similarly checking the second certificate having a valid certificate authority signature. Upon successful verification of the first and second certificates, a data exchange is implemented via the secure communication channel.

In one alternate embodiment, the first certificate and second certificate can be respectively stored within, and accessed from, a separate trusted authentication store also executing within the entrusted execution environment. Similarly, the first and second private keys can also be stored within, and accessed from, the trusted authentication store.

In one embodiment, the first certificate and the second certificate are provided in accordance with a version of the X509 encoding standard. The secure communication channel can be established in accordance with a version of the TLS (Transport Level Security) standard.

In this manner, embodiments of the present invention describe a method that not only securely pre-configures software components from the same author/designer, but also allows software components from different authors/designers to mutually authenticate each other, and from thereon to conduct authenticated and confidential data exchange. A common certificate authority mutually ensures the interaction between these distinct components can be trusted regardless of the fact that they both execute within an entrusted execution environment.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a flowchart of the steps of a key pair generation process in accordance with one embodiment of present invention.

FIG. 2 shows a diagram illustrating a key pair generation process in accordance with one embodiment of the present invention.

FIG. 3 shows a flowchart of the steps of a component build process in accordance with one embodiment of present invention.

FIG. 4 shows a diagram illustrating a component build process in accordance with one embodiment of the present invention.

FIG. 5 shows a flowchart of the steps of an external authentication component build process in accordance with one embodiment of present invention.

FIG. 6 shows a diagram illustrating an external authentication component build process in accordance with one embodiment of the present invention.

FIG. 7 shows a flowchart of the steps of an exemplary secure communication process in accordance with one embodiment of present invention.

FIG. 8 shows a diagram illustrating an exemplary secure communication process in accordance with one embodiment of the present invention.

FIG. 9 shows a diagram illustrating a computer system in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

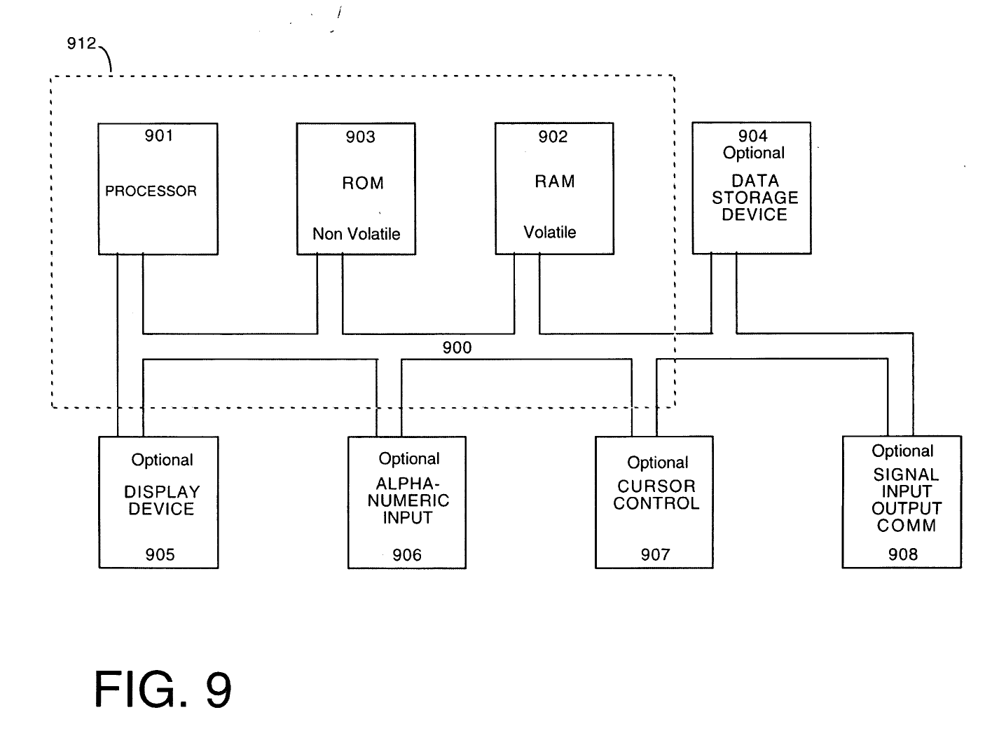

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system (e.g., computer system 912 of FIG. 9), or similar electronic computing device, that manipulates and transforms data represented as physical (electronic) quantities within the computer system's registers and memories into other data similarly represented as physical quantities within the computer system memories or registers or other such information storage, transmission or display devices.

### EMBODIMENTS OF THE INVENTION

Embodiments of the present invention provide for authenticated and confidential communication between two or more software components. Embodiments of the present invention implement a solution that provides software components that have preinstalled secure configuration functionality embedded within them. The preinstalled secure configuration functionality provides a number of advantages in comparison to the prior art, including, for example, the implementation of a robust and secure communication infrastructure that can be reliably employed, since the support for secure communication is built-in by the designer/software engineer.

Additionally, embodiments of the present invention describe a method that not only securely pre-configures software components from the same author/designer, but also allows software components from different authors/designers to mutually authenticate each other and from thereon to conduct authenticated and confidential data exchange, regardless of the conditions of the execution environment in which they operate. A method in accordance with the present invention relies upon a common certificate authority (e.g., a mutually trusted party) to ensure that the interaction between distinct components can be trusted regardless of the execution environment. Embodiments of the present invention and their benefits are further described below.

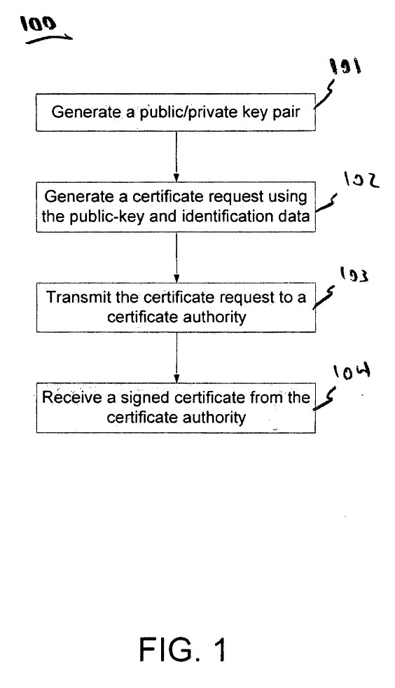

FIG. 1 shows a flowchart of the steps of a component build process 100 in accordance with one embodiment of present invention. As depicted in FIG. 1, process 100 shows the basic steps performed by a system designer, software engineer, component author, or the like, as she builds one or more a software components in accordance with one embodiment of the present invention.

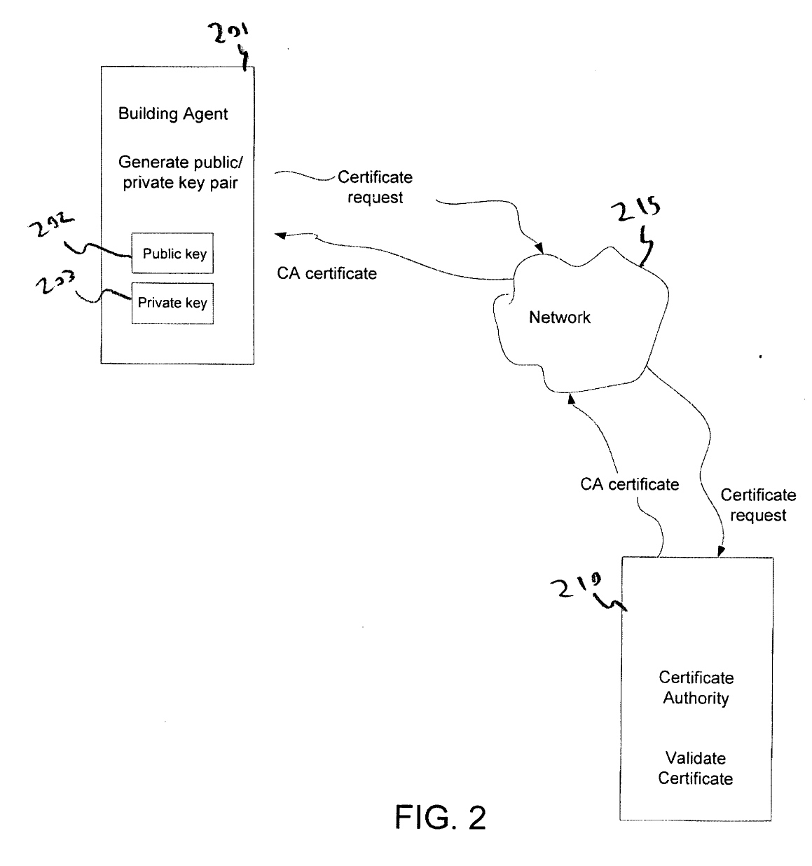

FIG. 2 shows a diagram illustrating process 100 of FIG. 1. Process 100 is described with reference to FIG. 2.

Process 100 begins in step 101, where a software designer/component author (e.g., building agent 201 of FIG. 2) generates a public-private key pair (e.g., public-key 202 and private key 203) for incorporation into a software component or a software application.

In one embodiment, an asymmetric encryption algorithm is employed that uses a pair of keys, one public and one private, for encryption. Generally, the public key 202 encrypts data/information, and the corresponding private key 203 decrypts it. The user keeps the private key 203 secret and uses it to encrypt digital signatures and to decrypt received messages. The user releases the public key 202 to the public, who can use it for encrypting messages to be sent to the user and for decrypting the user's digital signature. For digital signatures, the process is reversed, whereby the sender uses the secret private key 203 to create a unique electronic number that can be read by anyone possessing the corresponding public key 202, which verifies that the message is truly from the sender. For example the RSA algorithm (U.S. Pat. No. 4,405,829) describes a well-established mechanism to create a publishable public key and a secure private key.

In step 102, the software designer/component author (e.g., building agent 201) generates a certificate request to a certificate authority (e.g., certificate authority 210) using the public key 202 and certain identification data. The identification data comprises information sufficient to uniquely identify the building agent 201 (e.g., out of many hundreds of building agents that produce software components). Such information can include, for example, the name and address of the building agent 201, license number, etc. A common format of such certificates is the X.509 encoding format (IEFF RFC 2459).

In step 103, the resulting certificate request is transmitted from the building agent 201 to the certificate authority 210. Typically, the certificate authority is a well-known entity residing at some remote location away from the building agent 201, and the certificate request is transmitted via a public network 215 (e.g., the Internet). A commonly used format of the transmitted request is PKCS#7.

Generally, the certificate authority 210 operates as a trusted signer of digital certificates. A certificate authority may be an external issuing company (e.g., VeriSign Inc., etc.) or an internal company authority that has installed its own server (e.g., a companywide “Certificate Server”) for issuing and verifying certificates. A certificate authority is responsible for providing and assigning the unique strings of numbers that make up the “keys” (e.g., public-key 202 and private key 203) used in digital certificates for authentication and to encrypt and decrypt sensitive or confidential incoming and outgoing information.

In step 104, the software designer/component author (e.g., building agent 201) receives a resulting signed certificate from the certificate authority 210 via the network 215. The certificate from the certificate authority (e.g., the CA certificate) represents an assurance that a software component incorporating the CA certificate comes from a reputable source. The CA certificate provides information about the software component, such as, for example, the identity of the author/designer, the date on which the software component was registered with a certificate authority (CA), a measure of tamper-resistance, etc. In one embodiment, the CA certificate is based on public-key encryption technology, such as, for example, the X.509 encoding standard (IETF RFC 2459).

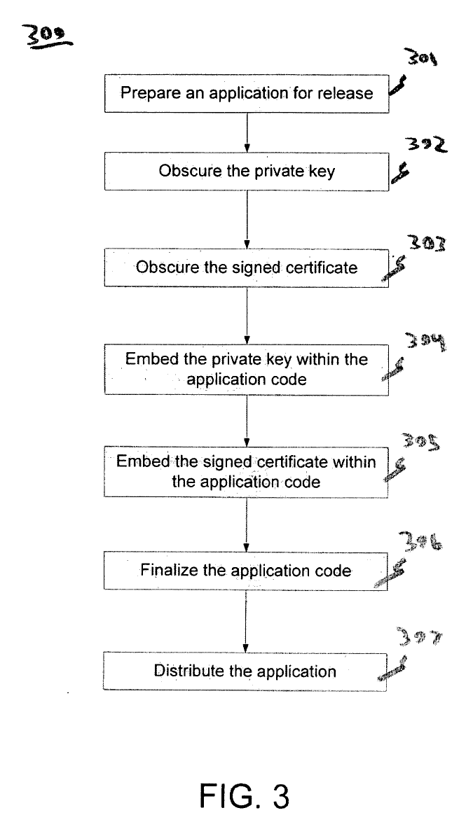

FIG. 3 shows a flowchart of the steps of a component build process 300 in accordance with one embodiment of present invention. As depicted in FIG. 3, process 300 shows the certificate and key hiding steps performed by a system designer, software engineer, component author, or the like, in accordance with one embodiment of the present invention.

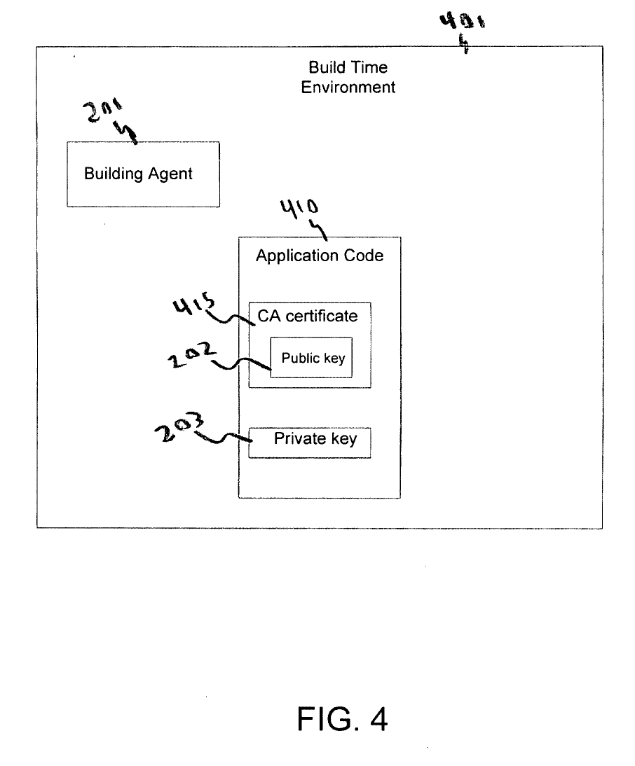

FIG. 4 shows a diagram illustrating process 300 of FIG. 3. Process 300 is described with reference to FIG. 4.

The signed certificate from the certificate authority 210 enables the building agent 201 to build a software component having preinstalled secure configuration functionality embedded within. The preinstalled secure configuration functionality provides a robust and secure communication infrastructure that can be reliably employed, as described above.

Process 300 begins in step 301, where the building agent 201 prepares an application within the build-time environment 401 for release and distribution. The application typically comprises a unit of computer executable software code (e.g., application code 410) and can be a component, a module, routine, or the like. For example, a component is generally an individual modular software routine that has been compiled and dynamically linked, and is ready to use with other components or programs. The term “module” generally refers to software routines, or components, that can be combined with other components to form an overall program. A “routine” generally refers to any section of code that can be invoked (e.g., executed) within a program.

In step 302, the private key 203 is “hidden” within the software comprising the application code 410. The private key 203 can be hidden within the application code 410 by, for example, obscuring the code comprising the private key 203. The code comprising the private key 203 can be obscured by spreading it out among the software code comprising the application 410. For example, the code comprising the private key 203 can be broken into a number of pieces and spread out among the application code 410 in such manner that only the application 410 can retrieve the pieces and re-assemble the private key 203 (e.g., since only the application 410 knows where to look for the pieces). This breaking up and spreading effectively hides the private key 203. Similarly, in step 303, the CA certificate 415 (e.g., including the public-key 202) is obscured and hidden within the software comprising the application code 410.

In step 304, the hidden private key 203 is embedded within the application code 410. In step 305, the hidden signed certificate (e.g., CA certificate 415) is similarly embedded within the application code 410. In step 306, the application code 410 is finalized. And in step 307, the finalized application is distributed (e.g., including the embedded hidden private key 202 and the embedded hidden CA certificate 415).

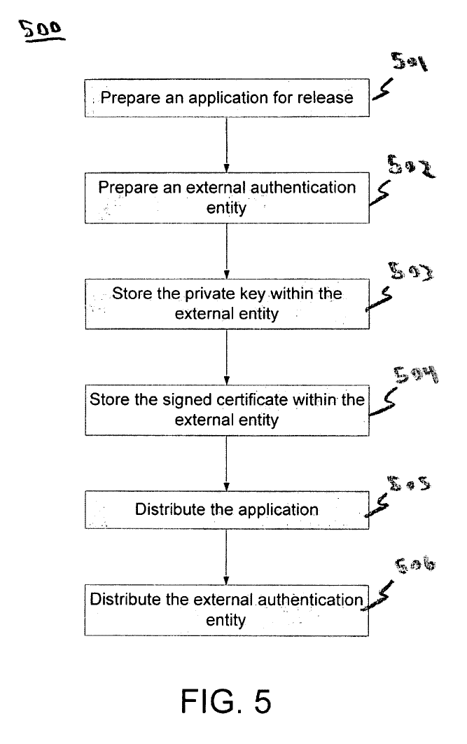

FIG. 5 shows a flowchart of the steps of an external trusted authentication store component build process 500 in accordance with one embodiment of present invention. As depicted in FIG. 5, process 500 shows the external trusted authentication store certificate and key storing steps performed by a system designer, software engineer, component author, in accordance with one embodiment of the present invention.

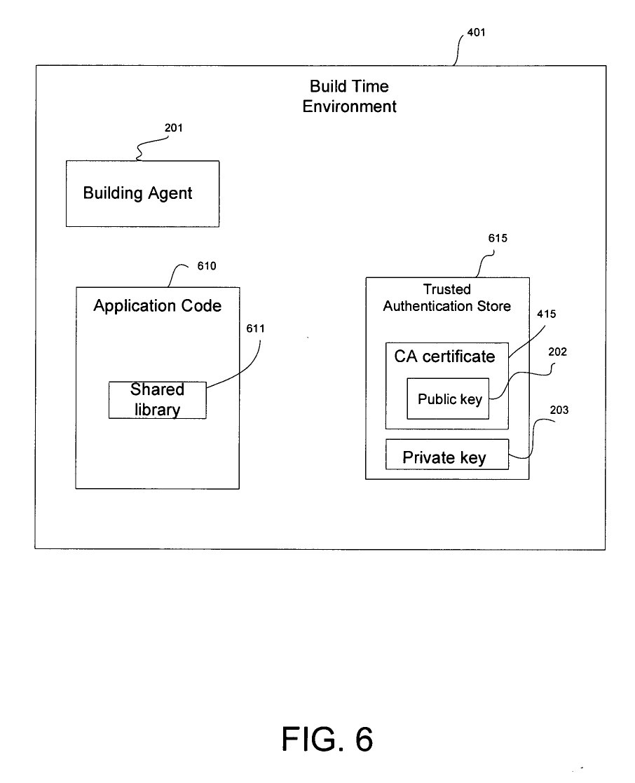

FIG. 6 shows a diagram illustrating process 500 of FIG. 5. Process 500 is described with reference to FIG. 6.

As described above, the incorporation of the private key and the CA certificate enables the building agent 201 to build a software component having preinstalled secure configuration functionality. However, process 500 describes an alternative embodiment, where the private key 203 and the CA certificate 415 are stored with an external trusted authentication store 615.

Process 500 begins in step 501, where the building agent 201 prepares an application within the build-time time environment 401 for release and distribution. In step 502, software code comprising an external trusted authentication store 615 (e.g., a module, component, etc.) is prepared by the building agent 201. In one embodiment, the building agent 201 builds a shared library 611. The shared library 611 functions with the trusted authentication store 615 to provide a convenient way for the software publisher (e.g., building agent 201) to package the resulting finished application. The shared library can securely access the certificate 415 and the private key 203 stored in the trusted authentication store. The shared library 611 comprises an integral part of the application 610. In step 503, the private key 203 is stored within the trusted authentication store 615. Similarly, in step 504, the CA certificate 415 (e.g., including the public-key 202) is stored within trusted authentication store 615. In step 505, the application code 610 comprising the software component is finalized and distributed. And in step 506, the trusted authentication store 615 is finalized and distributed (e.g., including the embedded hidden private key 202 and the embedded hidden CA certificate 415) with the application. In this alternative embodiment, instead of having the signed certificate 415 and the private key 203 hidden or otherwise obscured within the application code 610, a separate trusted authentication store is used to maintain the security.

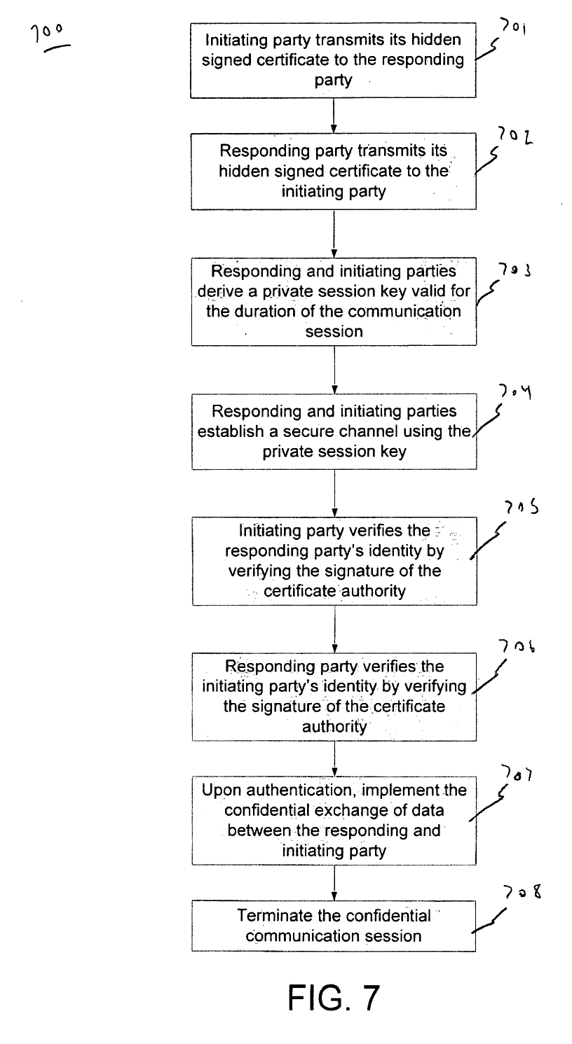

FIG. 7 shows a flowchart of the steps of a secure communication process 700 in accordance with one embodiment of present invention. As depicted in FIG. 7, process 700 shows the steps performed by two software components in establishing secure communication within an un-trusted execution environment in accordance with one embodiment of the present invention.

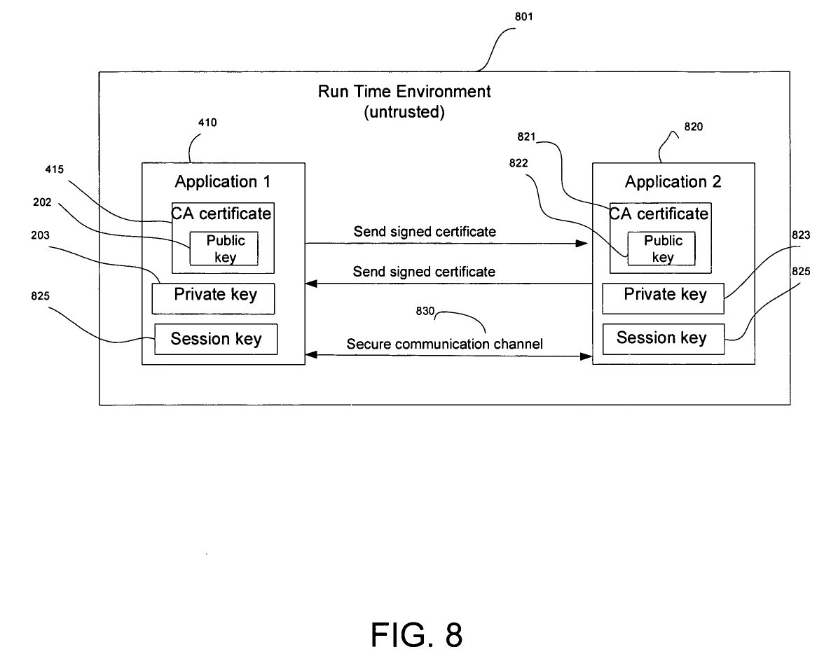

FIG. 8 shows a diagram illustrating process 700 of FIG. 7. Process 700 is described with reference to FIG. 8.

Process 700 begins in step 701, where an initiating component (e.g., application 410 of FIG. 8) transmits, or otherwise sends, its signed certificate (e.g., CA certificate 415) to a responding component (e.g., application 820 of FIG. 8). The initiating component sends its certificate 415 in response to a user request, or other requirement/need, to establish communication with the responding component. This can be, for example, two separately licensed functional modules needing to cooperate in order to render a DVD movie. As described above, the certificate 415 is hidden and must be accessed by the application 410 (e.g., using some specialized access means) in order to retrieve it from its hidden location (e.g., within the software code embodying application 410). For example, can be a case where a mutual authentication of software components coming from different parties is required. This can be, for example, an initiating application requesting sensitive information from a responding application and the mutual trust due to authentication is required in order for the responding application to give out that information and to rely on the information provided.

In step 702, the responding component (e.g., application 820) transmits, or otherwise sends, its signed certificate (e.g., CA certificate 821) to the transmitting component. As described above, both certificates 415 and 821 include their respective public keys (e.g., public-key 202 and public-key 822) and respective identification information. Additionally, as with certificate 415, the certificate 821 is hidden and must be accessed by the application 820 for retrieval.

In step 703, the initiating component and responding component (e.g., applications 410 and 820) derive a private session key 825 valid for the duration of the communication session. The applications 410 and 820 use the public-keys 202 and 822 within the CA certificates 415 and 821 to establish the session key 825. The session key 825 represents a “shared secret” common to both applications 410 and 820. Subsequently, in step 704, the private session key 825 is used to establish a secure channel 830 between the applications 410 and 820. The channel 830 is secure since data that is exchanged between the applications 410 and 820 via the channel 830 is encrypted. The respective private keys 203 and 823 enable the applications 410 and 820 to decrypt data transmitted from one to the other.

In step 705, the initiating component (e.g., application 410) verifies the responding component's identity by checking a certificate authority, or in other words by cryptographically verifying the signature of the certificate authority (e.g., certificate authority 210). When the initiating component detects the valid signature of the certificate authority 210, it knows the identity of the responding component (e.g., application 820) is valid.

In step 706, the responding component (e.g., application 820) similarly verifies the initiating component's identity by verifying the signature of the certificate authority. When the responding component detects the valid signature of the certificate authority 210, it knows the identity of the initiating component (e.g., application 410) is valid.

In step 707, now that the secure communication channel 830 has established and the identities of the initiating component and the responding component have been verified, the confidential exchange of data between the responding component and the initiating component is implemented across the secure communication channel 830.

Subsequently, in step 708, the confidential communication session is terminated. In one embodiment, the termination can occur after a preset time period. After the expiration of this period, a new confidential communication session can be negotiated and set up (e.g., by repeating steps 701-707). In another embodiment, the confidential communication session can remain existent until no longer needed by the applications.

It should be noted that, as described above, the TLS (transport level security) protocol comprises one common protocol for establishing an authenticated connections. The TLS protocol defines the process whereby the certificates are exchanged, ensures the exchanged certificates are valid, and that the root level certificate is in fact a pre-registered certificate. TLS also defines the process of deriving the shared session key and encrypting the communication with that session key.

In one embodiment, after the standard TLS protocol finishes, further specific validation occurs, where the trusted root level certificate is checked as to whether it is actually the one from the certificate authority (e.g., by comparing the identity string in the certificate and the fingerprint/digest of the trusted certificate with preconfigured data). This stringent requirement (e.g., that the trusted certificate is the same) ensures that only registered parties able to get their certificates signed by the certificate authority will be able to be authenticated.

Computer System Platform:

Referring to FIG. 9, a computer system 912 is illustrated. Within the following discussions of the present invention, certain processes and steps are discussed that are realized, in one embodiment, as a series of instructions (e.g., software program) that reside within computer readable memory units of system 912 and executed by processors of system 912. When executed, the instructions cause computer system 912 to perform specific actions and exhibit specific behavior which was described herein.

In general, the computer system 912 of the present invention includes an address/data bus 900 for communicating information, one or more central processor(s) 901 coupled with bus 900 for processing information and instructions, a computer readable volatile memory unit 902 (e.g., random access memory, static RAM, dynamic RAM, etc.) coupled with bus 900 for storing information and instructions for the central processor(s) 901, a computer readable non-volatile memory unit 903 (e.g., read only memory, programmable ROM, flash memory, EPROM, EEPROM, etc.) coupled with bus 900 for storing static information and instructions for processor(s) 901. Computer system 912 can optionally include a mass storage computer readable data storage device 904, such as a magnetic or optical disk and disk drive coupled with bus 900 for storing information and instructions. Optionally, computer system 912 can also include a display device 905 coupled to bus 900 for displaying information to the computer user, an alphanumeric input device 906 including alphanumeric and function keys coupled to bus 900 for communicating information and command selections to central processor(s) 901, a cursor control device 907 coupled to bus for communicating user input information and command selections to the central processor(s) 901, and a signal input/output device 908 coupled to the bus 900 for communicating messages, command selections, data, etc., to and from processor(s) 901. Program instructions executed by the computer system can be stored in RAM 902, ROM 903, or the storage device 904 and, when executed in a group, can be referred to as software components, logic blocks, procedures, routines and the like.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for secure communication for a software component in an un-trusted execution environment, comprising:
accessing a first certificate;
transmitting the first certificate to a responding software component;
receiving a second certificate from the responding software component;
generating a secure communication channel with the responding software component;
verifying an identity of the responding software component by checking the second certificate with respect to a certificate authority; and
implementing secure communication with the responding software component.

2. The method of claim 1, further comprising:
accessing a private key;
deriving a session key based on the private key; and
generating the secure communication channel with the responding software component by using the session key.

3. The method of claim 2, wherein the private key and the first certificate is hidden within software code comprising the software component.

4. The method of claim 2, wherein the first certificate and the private key are stored in an external trusted authentication store.

5. The method of claim 1, further comprising:
terminating the secure communication channel after a predetermined period of time.

6. The method of claim 1, further comprising:
terminating the secure communication channel after completion of the secure communication.

7. The method of claim 1, wherein the first certificate and the second certificate are in accordance with a version of an X509 encoding standard.

8. The method of claim 1, wherein the secure communication channel is established in accordance with a version of a TLS (Transport Level Security) standard.

9. A computer readable media storing computer readable code, which when executed by a processor of a computer system cause the computer system to implement a method for establishing secure communication for a software component in an un-trusted execution environment, the method comprising:
receiving a request for a communication with a responding software component;
in response to the request, establishing a secure communication channel with the responding software component by:
accessing a first certificate;
transmitting the first certificate to the responding software component;
receiving a second certificate from the responding software component;
establishing the secure communication channel with the responding software component;
verifying an identity of the responding software component by checking the second certificate with respect to a certificate authority; and
using the secure communication channel, implementing secure communication with the responding software component.

10. The computer readable media of claim 9, further comprising:
accessing a private key;
deriving a session key based on the private key; and
generating the secure communication channel with the responding software component by using the session key.

11. The computer readable media of claim 10, wherein the private key and the first certificate is hidden within software code comprising the software component.

12. The computer readable media of claim 10, wherein the first certificate and the private key are stored in an external trusted authentication store.

13. The computer readable media of claim 9, wherein the secure communication channel is terminated after a predetermined period of time.

14. The computer readable media of claim 9, wherein the secure communication channel is terminated after completion of the secure communication.

15. The computer readable media of claim 9, wherein the first certificate and the second certificate are in accordance with a version of an X.509 encoding standard.

16. The computer readable media of claim 9, wherein the secure communication channel is established in accordance with a version of a TLS (Transport Level Security) standard.

17. A method for implementing secure communication in an un-trusted execution environment and between a first software component and a second software component, comprising:
transmitting a first certificate to the second component;
transmitting a second certificate to the first component;
generating a secure communication channel between the first component and the second component by the second component using a first public key of the first certificate and the first component using a second public key of the second certificate;
verifying an identity of the first component by the second component checking the first certificate with respect to a certificate authority;
verifying an identity of the second component by the first component checking the second certificate with respect to the certificate authority;
upon successful verification of the first certificate and the second certificate, implementing a data exchange via the secure communication channel.

18. The method of claim 17, wherein the first private key and the first certificate is hidden within software code comprising the first component and the second private key and the second certificate is hidden within software code comprising the second component.

19. The method of claim 17, wherein the first private key and the first certificate and the second private key and the second certificate are stored in an external trusted authentication store.

20. The method of claim 17, wherein the first certificate and the second certificate are in accordance with a version of an X509 encoding standard.

21. The method of claim 17, wherein the secure communication channel is established in accordance with a version of a TLS (Transport Level Security) standard.

22. A method for building a software component configured for secure communication in an un-trusted execution environment, comprising:
generating a first certificate;
building a software component and hiding the first certificate with software code comprising the software component; and
configuring the software component to implement secure communication at run-time in the un-trusted execution environment by:
accessing the first certificate;
transmitting the first certificate to a responding software component;
receiving a second certificate from the responding software component;
generating a secure communication channel with the responding software component;
verifying an identity of the responding software component by checking the second certificate with respect to a certificate authority; and
implementing secure communication with the responding software component.
